(19) United States
(12) Patent Application Publication
(10) Pub. No.: US 2026/0084132 A1
(43) Pub. Date: Mar. 26, 2026

(54) SYNTHETIC COLUMN FOR NUCLEIC ACID SYNTHESIS

(71) Applicant: Industrial Technology Research Institute, Hsinchu (TW)

(72) Inventors: Fang-Cheng Li, Kaohsiung City (TW); Wei-Chin Huang, Tainan City (TW); An-Li Chen, Tainan City (TW); Sung-Ho Liu, Kaohsiung City (TW); Ming-Chun Lin, Hsinchu City (TW); Chun-Ting Lai, Taoyuan City (TW)

(73) Assignee: Industrial Technology Research Institute, Hsinchu (TW)

(21) Appl. No.: 18/943,766

(22) Filed: Nov. 11, 2024

(30) Foreign Application Priority Data
Sep. 24, 2024 (TW) 113136113

(51) Int. Cl. B01J 19/00

(52) U.S. Cl. CPC B01J 19/0046; B01J 2219/00331; B01J 2219/00722

(57) ABSTRACT

A synthetic column for nucleic acid synthesis includes a column body, first helical blades, and second helical blades. The column body has an axis, an inner wall, and an inlet end and an outlet end opposite to each other. The first helical blades helically extend in a first helical direction from the axis toward the inner wall. Two ends of each first helical blade are connected to the axis and the inner wall. The second helical blades helically extend in a second helical direction from the inner wall toward the axis. The first helical direction is different from the second helical direction. The first and second helical blades are arranged in an alternating manner. One end of each second helical blade is connected to the inner wall, and the other end has a second helical side gradually approaching the axis from the inlet end toward the outlet end.

### CROSS-REFERENCE TO RELATED APPLICATION

This application claims the priority benefit of Taiwan application serial no. 113136113, filed on Sep. 24, 2024. The entirety of the above-mentioned patent application is hereby incorporated by reference herein and made a part of this specification.

### TECHNICAL FIELD

The disclosure relates to a synthetic column, and in particular, relates to a synthetic column for nucleic acid synthesis.

### BACKGROUND

Generally, in certain circumstance, a synthetic column for nucleic acid synthesis mainly uses a single flow channel for synthesis, so a structure thereof is relatively simple. However, in such case, the use of a single flow channel may usually requires introduction of a higher reaction equivalent, and the flow velocity distribution may be excessively concentrated. As a result of such case, higher costs are needed but lower yields are produced.

### SUMMARY

The disclosure provides a synthetic column for nucleic acid synthesis, which includes a column body, a plurality of first helical blades, and a plurality of second helical blades. The column body has an axis, an inner wall, and an inlet end and an outlet end opposite to each other. The first helical blades helically extend in a first helical direction from the axis toward the inner wall. Two ends of each of the first helical blades are connected to the axis and the inner wall. The second helical blades helically extend in a second helical direction from the inner wall toward the axis, and the first helical direction is different from the second helical direction. The first helical blades and the second helical blades are arranged in an alternating manner. One end of each of the second helical blades is connected to the inner wall, and the other end of each of the second helical blades has a second helical side. The second helical side gradually approaches the axis from the inlet end toward the outlet end.

bladeshelical bladeshelical bladeshelical bladeshelicalhelical bladeshelical bladesSeveral exemplary embodiments accompanied with figures are described in detail below to further describe the disclosure in details.

### BRIEF DESCRIPTION OF THE DRAWINGS

The accompanying drawings are included to provide a further understanding, and are incorporated in and constitute a part of this specification. The drawings illustrate exemplary embodiments and, together with the description, serve to explain the principles of the disclosure.

FIG. 1 and FIG. 2 are schematic three-dimensional views of a synthetic column for nucleic acid synthesis in different viewing angles according to one embodiment of the disclosure.

FIG. 3 is a schematic left side view of the synthetic column for nucleic acid synthesis in FIG. 1.

FIG. 4 is a schematic right side view of the synthetic column for nucleic acid synthesis in FIG. 2.

FIG. 5 is a schematic cross-sectional view of the synthetic column for nucleic acid synthesis in FIG. 1.

FIG. 6 is a schematic partially enlarged view of the synthetic column for nucleic acid synthesis in FIG. 3.

FIG. 7 is a schematic partially enlarged view of the synthetic column for nucleic acid synthesis in FIG. 4.

### DETAILED DESCRIPTION OF DISCLOSURE EMBODIMENTS

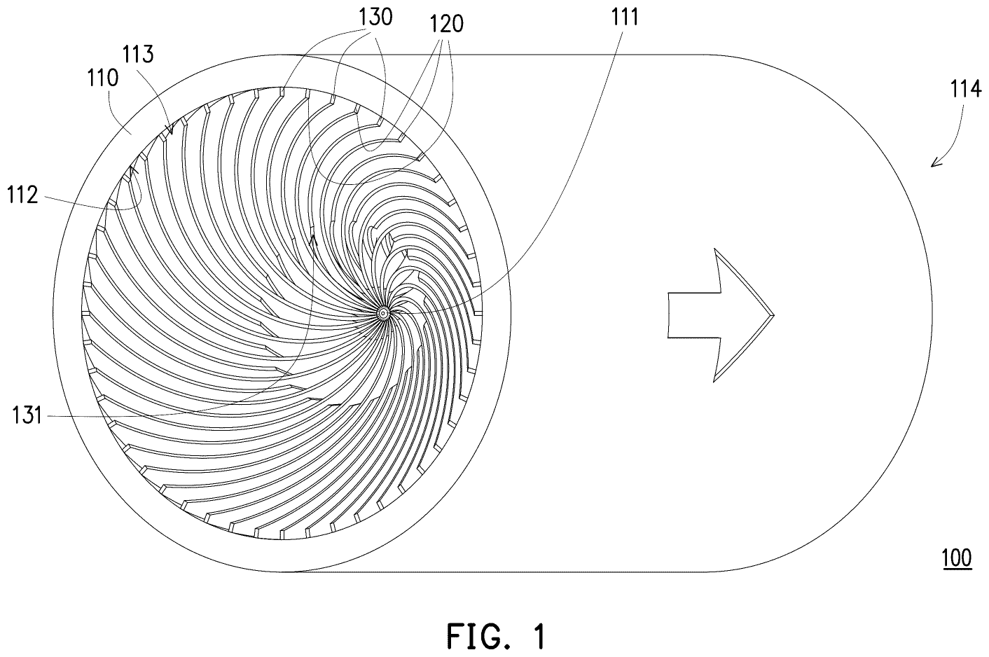

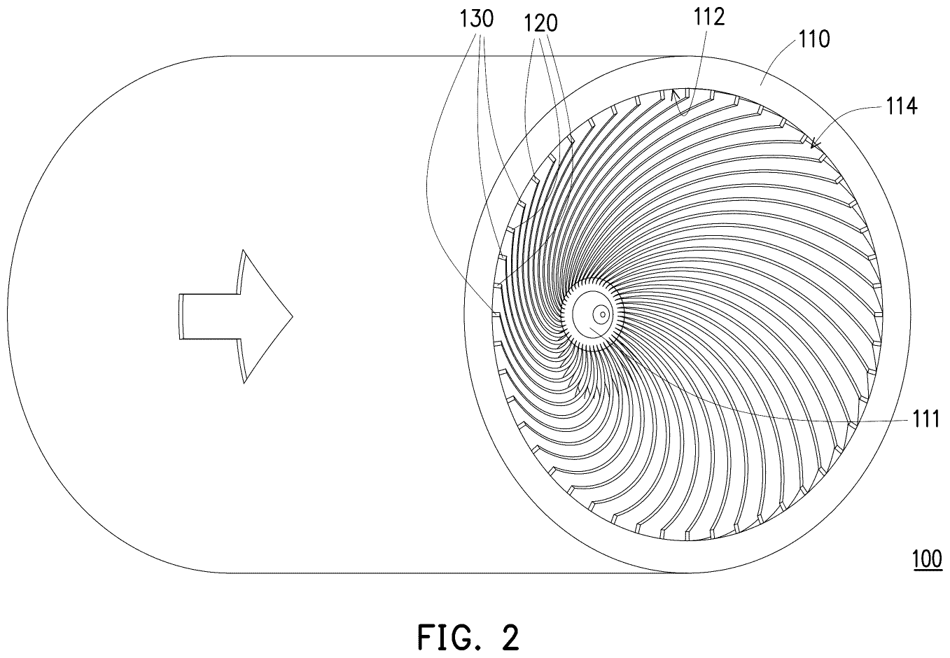

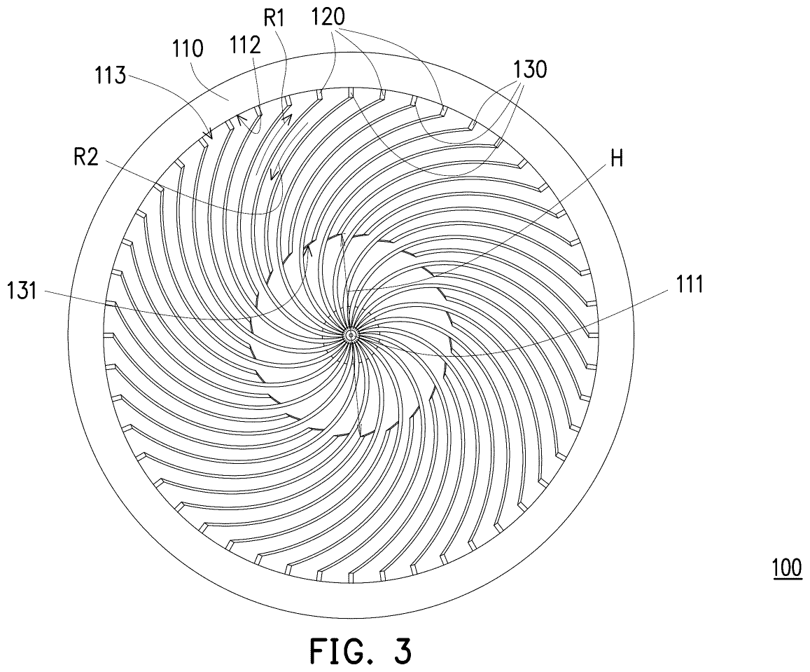

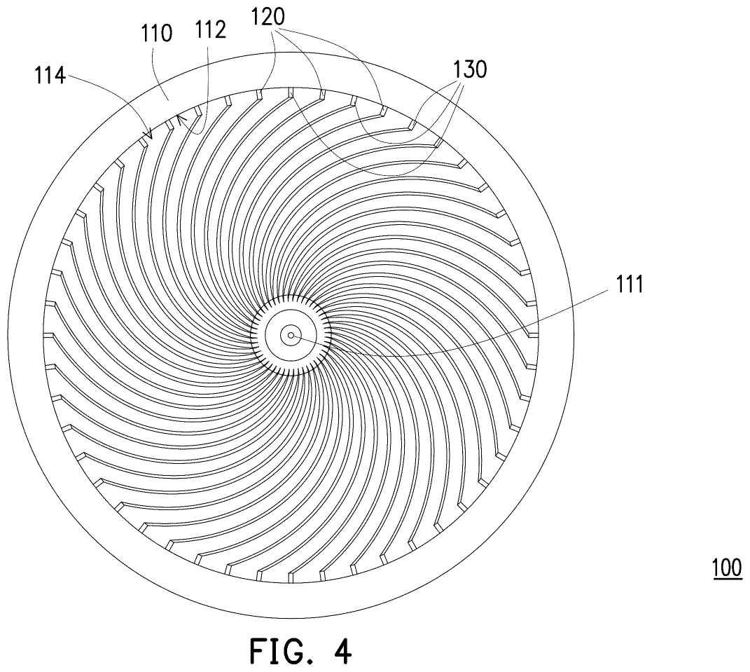

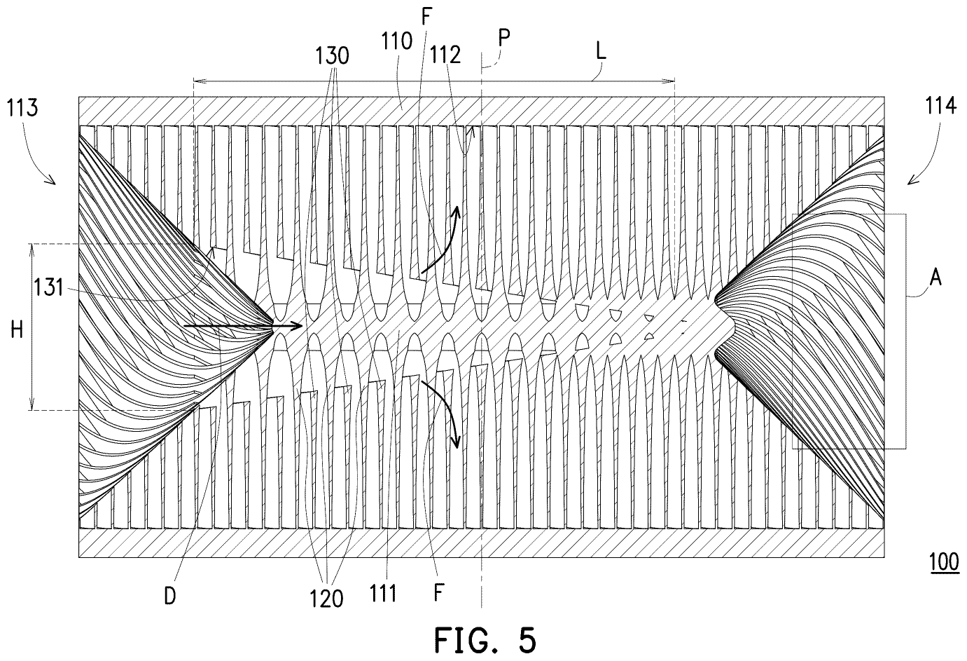

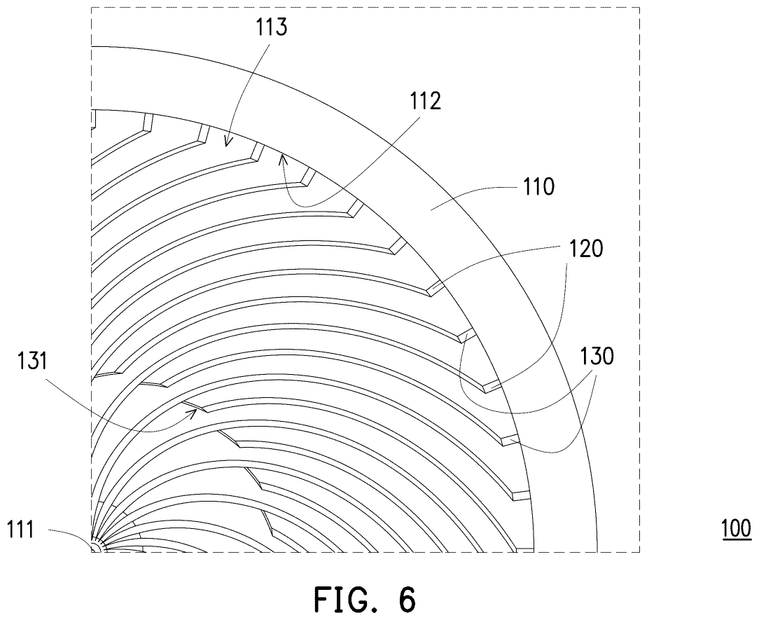

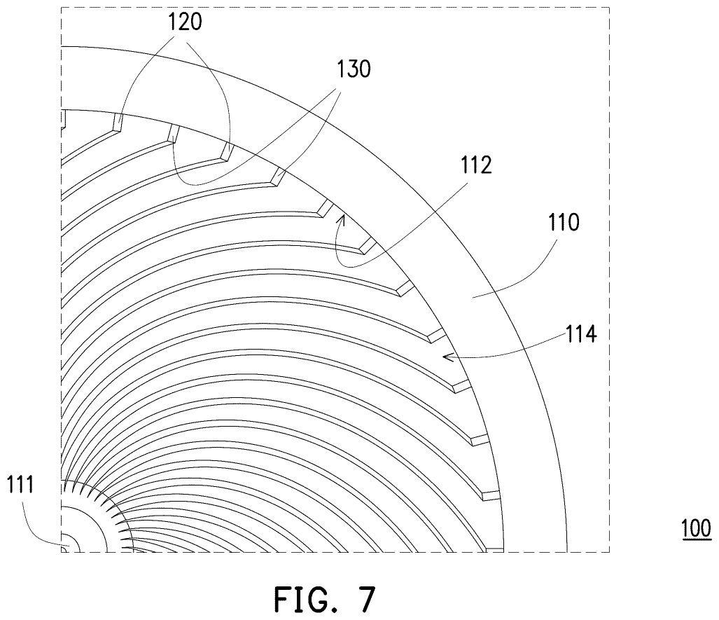

FIG. 1 and FIG. 2 are schematic three-dimensional views of a synthetic column for nucleic acid synthesis in different viewing angles according to one embodiment of the disclosure. FIG. 3 is a schematic left side view of the synthetic column for nucleic acid synthesis in FIG. 1. FIG. 4 is a schematic right side view of the synthetic column for nucleic acid synthesis in FIG. 2. FIG. 5 is a schematic cross-sectional view of the synthetic column for nucleic acid synthesis in FIG. 1. FIG. 6 is a schematic partially enlarged view of the synthetic column for nucleic acid synthesis in FIG. 3. FIG. 7 is a schematic partially enlarged view of the synthetic column for nucleic acid synthesis in FIG. 4. Referring to FIG. 1 to 7, a synthetic column 100 for nucleic acid synthesis of the disclosure includes a column body 110, a plurality of first helical blades 120, and a plurality of second helical blades 130.

The column body 110 is generally in a shape of a perfectly round tube, but the disclosure is not limited thereto. The column body 110 has an axis 111, an inner wall 112, and an inlet end 113 and an outlet end 114 opposite to each other.

The first helical blades 120 helically extend in a first helical direction R1 from the axis 111 toward the inner wall 112, and two ends of each of the first helical blades 120 are connected to the axis 111 and the inner wall 112.

The second helical blades 130 helically extend in a second helical direction R2 from the inner wall 112 toward the axis 111, and the first helical direction R1 is different from the second helical direction R2. The first helical blades 120 and the second helical blades 130 are alternately arranged in an alternating manner at specific intervals. The first helical blades 120 and the second helical blades 130 extend around the inner wall 112. One end of each of the second helical blades 130 is connected to the inner wall 112, and the other end of each of the second helical blades 130 has a second helical side 131. The second helical side 131 gradually approaches the axis 111 from the inlet end 113 toward the outlet end 114. In this way, a lower input reaction equivalent demand is needed and a uniform flow velocity distribution is provided, so costs are reduced and increased yields are achieved.

In an actual structural layout of the overall synthetic column 100 for nucleic acid synthesis, the axis 111 is, for example, taken as a reference line, the first helical blades 120 are symmetrical to each other on two opposite sides of the axis 111, and the second helical blades 130 are symmetrical to each other on two opposite sides of the axis 111, but the disclosure is not limited thereto.

A number of the first helical blades 120 and the second helical blades 130 arranged in the alternating manner may be designed according to a diameter and a length of the column body 110. In the disclosure, a total number of the first helical blades 120 and the second helical blades 130 is 48 pieces. Namely, the number of the first helical blades 120 is 24 pieces, and the number of the second helical blades 130 is also 24 pieces, and they are arranged as the first helical blade 120, followed by the second helical blade 130, and then the first helical blade 130, and different helical blades are repeatedly arranged in alternation until they are completely distributed on the column body 110, where intervals thereof are equidistant and arranged equally in a complete circle of the column body 110, but the disclosure is not limited thereto.

In other embodiments, different numbers of the first helical blades and the second helical blades may be adopted.

On the other hand, the first helical blades 120 extend inward in an extending direction of the axis of the column body 110 in a mirror pattern or a mutual symmetrical pattern on two opposite sides of the column body 110. In one embodiment, a geometric intermediate plane P may be defined between the inlet end 113 and the outlet end 114 of the column body 110, where the geometric intermediate plane P is located exactly in the middle of the column body 110, and the geometric intermediate plane P is perpendicular to the axis 111. Taking the geometric intermediate plane P as a reference line, the first helical blades 120 are symmetrical to each other on two opposite sides of the geometric intermediate plane P. However, the second helical blades 130 have the second helical sides 131, and the second helical sides 131 of the second helical blades 130 gradually approach the axis 111 from the inlet end 113 toward the outlet end 114 and present a tapered section. Particularly, the design layout of the second helical sides 131 presenting the tapered section in the extending direction of the axis 111 makes the second helical blades 130 asymmetrical on the two opposite sides of the geometric intermediate plane P.

An outlet region A is actually defined at the outlet end 114, and the inner wall 112, the first helical blades 120 and the second helical blades 130 form at least one flow channel for a fluid to pass through. Due to the design of the tapered section inside the synthetic column 100, the fluid constantly flows unidirectionally in a fluid flow direction D, so that a fluid flow velocity F when the fluid passes through the synthetic column 100 increases from the axis 111 of the synthetic column 100 toward the inner wall 112. In other words, the closer the position is to the inner wall 112, the higher the fluid flow velocity F is. Therefore, the fluid may flow out from the outlet end 114 evenly, so a dead zone in the synthetic column 100 where no fluid passes through is effectively reduced, and the fluid is prevented from concentrating on the outlet region A to cause a jet flow.

A dead zone of a low-velocity zone of the fluid flow velocity of the synthetic column 100 may be less than 5%, and a pipe pressure loss can also be maintained below 5%.

There is an identical equation relationship among a fluid flow rate, a flow channel area, and a pipe length of the synthetic column 100, where the identical equation relationship is defined as R, the fluid flow rate is defined as Q, the flow channel area is defined as A, and the pipe length is defined as L, the identical equation relationship R is:

$$R = \frac{A * L}{{Q}^{n}} ,$$

where n is between 0.35 and 0.51, but the disclosure is not limited thereto.

In addition, a ratio between an opening inner diameter H of the second helical side 131 at the inlet end 113 and a helical extending length L of the second helical side 131 is α:

$$α = \frac{H}{L} .$$

In the disclosure, a structure of the synthetic column 100 is suitable to be made through 3D printing, and a material thereof includes titanium alloy, stainless steel, aluminum alloy or other metals. The synthetic column 100 is suitable for providing polymers to be fixed on a surface of a metal pipe in a grafting modification manner, where tail ends of the polymers have specific functional groups, but the disclosure is not limited thereto.

In other embodiments, the synthetic column may be made through general processing.

In view of the foregoing, in the synthetic column for nucleic acid synthesis of the disclosure, the first helical blades helically extend in the helical direction from the axis toward the inner wall, and two ends of each of the first helical blades are connected to the axis and the inner wall. The second helical blades helically extend in the helical direction from the inner wall toward the axis, and the first helical blades and the second helical blades are arranged in an alternating manner. One end of each of the second helical blades is connected to the inner wall, and the other end of each of the second helical blades has the second helical side. The second helical side gradually approaches the axis from the inlet end toward the outlet end, so a lower input reaction equivalent demand is needed, a uniform flow velocity distribution is provided, costs are reduced, and yields are increased.

Hence, the aforementioned disclosure is directed to a synthetic column for nucleic acid synthesis having a lower input reaction equivalent demand, providing a uniform flow velocity distribution, requiring reduced costs, and producing improved yields. It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A synthetic column for nucleic acid synthesis, comprising:
a column body having an axis, an inner wall, and an inlet end and an outlet end opposite to each other;
a plurality of first helical blades, two ends of each of the first helical blades being connected to the axis and the inner wall; and
a plurality of second helical blades, the first helical blades and the second helical blades being alternately arranged in an alternating manner at specific intervals, wherein one end of each of the second helical blades is connected to the inner wall, and the other end has a second helical side, and the second helical side gradually approaches the axis from the inlet end toward the outlet end.

2. The synthetic column for nucleic acid synthesis according to claim 1, wherein the first helical blades and the second helical blades extend around the inner wall.

3. The synthetic column for nucleic acid synthesis according to claim 1, wherein the first helical blades helically extending in a first helical direction from the axis toward the inner wall, the second helical blades helically extending in a second helical direction from the inner wall toward the axis, and the first helical direction being different from the second helical direction.

4. The synthetic column for nucleic acid synthesis according to claim 1, wherein the first helical blades are symmetrical to each other on two opposite sides of the axis.

5. The synthetic column for nucleic acid synthesis according to claim 1, wherein a geometric intermediate plane is defined between the inlet end and the outlet end of the column body, the geometric intermediate plane is perpendicular to the axis, and the first helical blades are symmetrical to each other on two opposite sides of the geometric intermediate plane.

6. The synthetic column for nucleic acid synthesis according to claim 1, wherein the first helical blades extend inward in an extending direction of the axis in a mirror pattern or a mutual symmetrical pattern on two opposite sides of the column body.

7. The synthetic column for nucleic acid synthesis according to claim 1, wherein the second helical blades are symmetrical to each other on two opposite sides of the axis.

8. The synthetic column for nucleic acid synthesis according to claim 1, wherein the second helical side presents a tapered section in an extending direction of the axis.

9. The synthetic column for nucleic acid synthesis according to claim 1, wherein a geometric intermediate plane is defined between the inlet end and the outlet end of the column body, the geometric intermediate plane is perpendicular to the axis, and the second helical blades are asymmetrical on two opposite sides of the geometric intermediate plane.

10. The synthetic column for nucleic acid synthesis according to claim 1, wherein the inner wall, the first helical blades, and the second helical blades form at least one flow channel for a fluid to pass through, and a fluid flow velocity when the fluid passes through the synthetic column increases from the axis of the synthetic column toward the inner wall.

11. The synthetic column for nucleic acid synthesis according to claim 1, wherein there is an identical equation relationship among a fluid flow rate, a flow channel area, and a pipe length.

12. The synthetic column for nucleic acid synthesis according to claim 11, wherein the identical equation relationship is R, the fluid flow rate is Q, the flow channel area is A, the pipe length is L, and the identical equation relationship R is:
$$R = \frac{A * L}{{Q}^{n}} ,$$
wherein n is between 0.35 and 0.51.

13. The synthetic column for nucleic acid synthesis according to claim 12, wherein a ratio between an opening inner diameter H of the second helical side at the inlet end and a helical extending length L of the second helical side is α:
$$α = \frac{H}{L} .$$

14. The synthetic column for nucleic acid synthesis according to claim 1, wherein the synthetic column is produced through 3D printing or general processing.

15. The synthetic column for nucleic acid synthesis according to claim 1, wherein a material of the synthetic column comprises titanium alloy, stainless steel, aluminum alloy, or other metals.
